(19) United States
(12) Patent Application Publication
(10) Pub. No.: US 2009/0091798 A1
(43) Pub. Date: Apr. 9, 2009

(54) APPAREL AS EVENT MARKER

(76) Inventors: Joel S. Lawther, Pittsford, NY (US); Madirakshi Das, Penfield, NY (US); Dale F. McIntyre, Honeoye Falls, NY (US); Alexander C. Loui, Penfield, NY (US); Peter O. Stubler, Rochester, NY (US)

Correspondence Address: Frank Pincelli, Patent Legal Staff;Eastman Kodak Company, 343 State Street, Rochester, NY, 14650-2201, US

(21) Appl. No.: 11/867,719

(22) Filed: Oct. 5, 2007

(51) Int. Cl. G06F 15/00

(52) U.S. Cl. 358/3.28

(57) ABSTRACT

A method of characterizing images taken during a event into one or more sub-events is disclosed. The method includes; acquiring a collection of images taken during the event; identifying one or more particular person(s) in the collection and the apparel associated with the identified person; searching the collection to identify if the apparel associated with identified particular person(s) has been changed during the event; identifying one or more sub-events for those images in which the particular person(s) have changed apparel.

### CROSS-REFERENCE TO RELATED APPLICATION

Reference is made to commonly assigned U.S. patent application Ser. No. 11/263,156, filed Oct. 3, 2005, entitled “Determining a Particular Person From a Collection” by Andrew C. Gallagher et al; U.S. patent application Ser. No. 11/755,343, filed May 30, 2007, entitled “Composite Person Model From Image Collection” by Joel S. Lawther et al.; and U.S. patent application Ser. No. 11/427,352, filed Jun. 29, 2006, entitled “Using Background For Searching Image Collections” by Madirakshi Das et al., the disclosures of which are incorporated herein by reference.

### FIELD OF THE INVENTION

The present invention relates to the set production of images into event sets using apparel.

### BACKGROUND OF THE INVENTION

With the advent of digital photography, consumers are amassing large collections of digital images and videos. The average number of images captures with digital cameras per photographer is still increasing each year. Now that multi-gigabyte camera cards and terabyte hard drives are commonplace in the home, there is limited quantity of digital images that can be captured. Consequently, the organization and retrieval of images and videos is already a problem for the typical consumer. Currently, the length of time spanned by a typical consumer's digital image collection is only a few years. The organization and retrieval problem will continue to grow as the length of time spanned by the average digital image and video collection increases.

Furthermore, it is an interest of the user, to organize images into logical sets. From these sets, images can be retrieved in an intuitive manner. Yet, even with large amounts of computing power and memory, dividing images into sets is a tedious, laborious task. In addition, although there are methods of organizing images by date, there are many cameras without an accurate date or time on the internal clock. In addition, many pictures have no date or time assigned to them from earlier days of printing them out and storing them in shoeboxes or albums.

### SUMMARY OF THE INVENTION

It is an object of the present invention to readily identify persons of interests and the features and to use them to produce event image sets in a digital image collection. This object is achieved by a method of characterizing images taken during an event into one or more sub-events, comprising:
a acquiring a collection of images taken during the event;
b. identifying one or more particular person(s) in the collection and the apparel associated with the identified person(s);
c. searching the collection to identify if the apparel associated with identified particular person(s) has been changed during the event; and
d. identifying one or more sub-events for those images in which the particular person(s) have changed apparel.

It is another object to produce image event sets using facial recognition. This object is achieved by a method of dividing images into event image sets, comprising:
a. acquiring a collection of images;
b. identifying one or more particular person(s) and the unique apparel associated with the particular person(s) in two or more images;
c. assigning a likelihood score of event image set assignment to each identified image in proportion to the number of particular person(s) with consistently unique apparel in the identified image(s).

These methods have the advantage of enabling organization of digital images into events or sub-events from a larger collection images. The present invention enables the sorting and production of event image sets of people using apparel without depending on date and time that the pictures were taken.

### BRIEF DESCRIPTION OF THE DRAWINGS

The subject matter of the invention is described with reference to the embodiments shown in the drawings.

FIG. 1 is a block diagram of a camera phone based imaging system that can implement the present invention;

FIG. 2 is a block diagram of an embodiment of the present invention for composite and extracted image segments for person identification;

FIG. 3 is a flow chart of an embodiment of the present invention for characterizing images taken during an event into one or more sub-events;

FIG. 4 is a representation of a set of person profiles associated with event images;

FIG. 5 is a collection of image acquired from an event;

FIG. 6 is a representation of face points and facial features of a person;

FIG. 7 is a representation of organization of images at an event by people and features;

FIG. 8 is an intermediate representation of event data;

FIG. 9 is a resolved representation of an event data set;

FIG. 10 is a visual representation of the resolved event data set;

FIG. 11 is an updated representation of person profiles associated with event images; and

FIG. 12 is a flow chart for dividing images into image event sets.

### DETAILED DESCRIPTION OF THE INVENTION

In the following description, some embodiments of the present invention will be described as software programs. Those skilled in the art will readily recognize that the equivalent of such a method can also be constructed as hardware or software within the scope of the invention.

Because image manipulation algorithms and systems are well known, the present description will be directed in particular to algorithms and systems forming part of, or cooperating more directly with, the method in accordance with the present invention. Other aspects of such algorithms and systems, and hardware or software for producing and otherwise processing the image signals involved therewith, not specifically shown or described herein can be selected from such systems, algorithms, components, and elements known in the art. Given the description as set forth in the following specification, all software implementation thereof is conventional and within the ordinary skill in such arts.

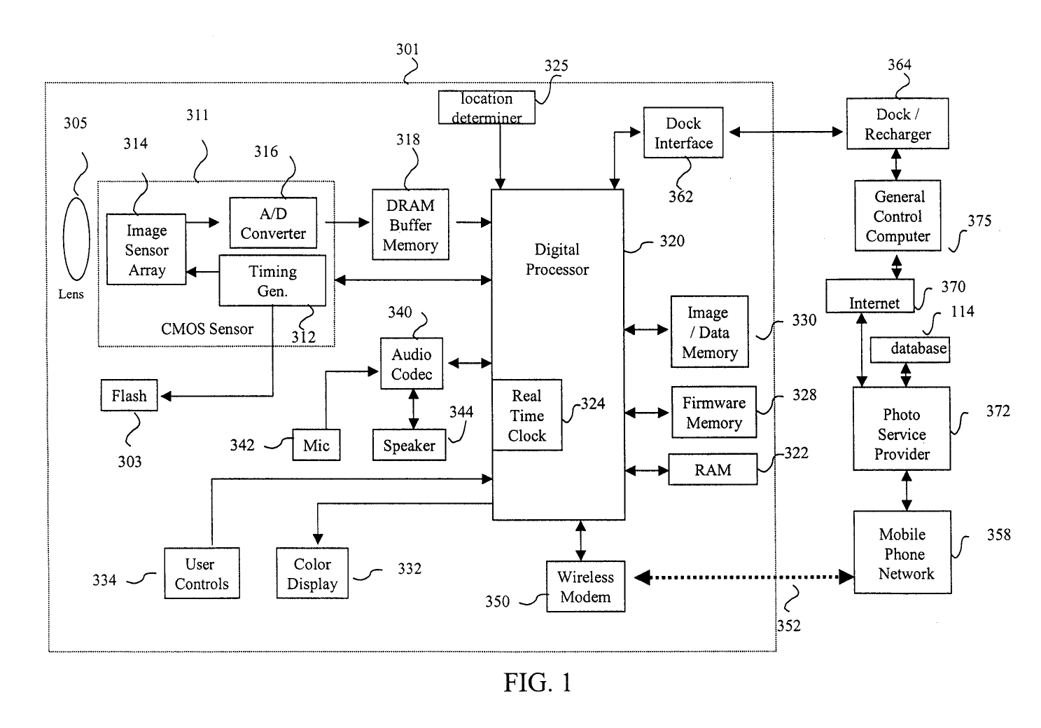

FIG. 1 is a block diagram of a digital camera phone 301 based imaging system that can implement the present invention. The digital camera phone 301 is one type of digital camera. Preferably, the digital camera phone 301 is a portable battery operated device, small enough to be easily handheld by a user when capturing and reviewing images. The digital camera phone 301 produces digital images that are stored using the image data/memory 330, which can be, for example, internal Flash EPROM memory, or a removable memory card. Other types of digital image storage media, such as magnetic hard drives, magnetic tape, or optical disks, can alternatively be used to provide the image/data memory 330.

The digital camera phone 301 includes a lens 305 that focuses light from a scene (not shown) onto an image sensor array 314 of a CMOS image sensor 311. The image sensor array 314 can provide color image information using the well-known Bayer color filter pattern. The image sensor array 314 is controlled by timing generator 312, which also controls a flash 303 in order to illuminate the scene when the ambient illumination is low. The image sensor array 314 can have, for example, 1280 columns×960 rows of pixels.

In some embodiments, the digital camera phone 301 can also store video clips, by summing multiple pixels of the image sensor array 314 together (e.g. summing pixels of the same color within each 4 column×4 row area of the image sensor array 314) to produce a lower resolution video image frame. The video image frames are read from the image sensor array 314 at regular intervals, for example using a 24 frame per second readout rate.

The analog output signals from the image sensor array 314 are amplified and converted to digital data by the analog-to-digital (A/D) converter circuit 316 on the CMOS image sensor 311. The digital data is stored in a DRAM buffer memory 318 and subsequently processed by a digital processor 320 controlled by the firmware stored in firmware memory 328, which can be flash EPROM memory. The digital processor 320 includes a real-time clock 324, which keeps the date and time even when the digital camera phone 301 and digital processor 320 are in their low power state.

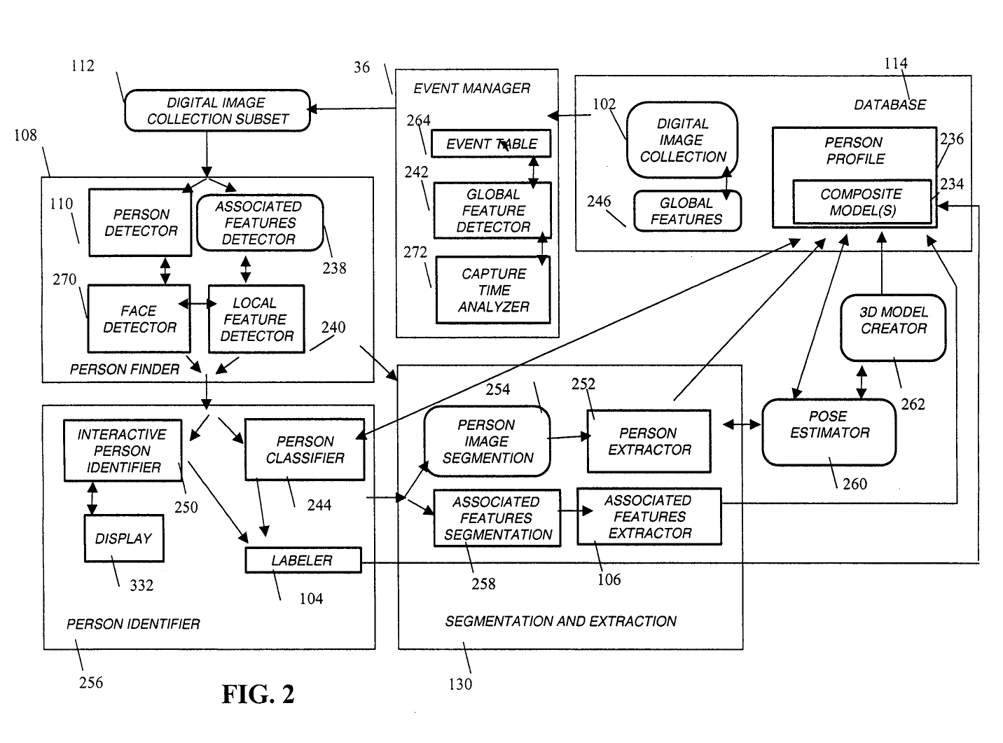

The processed digital image files are stored in the image/data memory 330. The image/data memory 330 can also be used to store the personal profile information 236 (shown in FIG. 2), in database 114. The image/data memory 330 can also store other types of data, such as phone numbers, to-do lists, and the like.

In the still image mode, the digital processor 320 performs color interpolation followed by color and tone correction, in order to produce rendered sRGB image data. The digital processor 320 can also provide various image sizes selected by the user. The rendered sRGB image data is then JPEG compressed and stored as a JPEG image file in the image/data memory 330. The JPEG file uses the so-called “Exif” image format described earlier. This format includes an Exif application segment that stores particular image metadata using various TIFF tags. Separate TIFF tags can be used, for example, to store the date and time the picture was captured, the lens f/number and other camera settings, and to store image captions. In particular, the Image Description tag can be used to store labels. The real-time clock 324 provides a capture date/time value, which is stored as date/time metadata in each Exif image file.

A location determiner 325 provides the geographic location associated with an image capture. The location is preferably stored in units of latitude and longitude. Note that the location determiner 325 can determine the geographic location at a time slightly different than the image capture time. In that case, the location determiner 325 can use a geographic location from the nearest time as the geographic location associated with the image. Alternatively, the location determiner 325 can interpolate between multiple geographic positions at times before or after the image capture time to determine the geographic location associated with the image capture. Interpolation can be necessitated because it is not always possible for the location determiner 325 to determine a geographic location. For example, the GPS receivers often fail to detect signal when indoors. In that case, the last successful geographic location reading (i.e. prior to entering the building), can be used by the location determiner 325 to estimate the geographic location associated with a particular image capture. The location determiner 325 can use any of a number of methods for determining the location of the image. For example, the geographic location can be determined by receiving communications from the well-known Global Positioning Satellites (GPS).

The digital processor 320 also produces a low-resolution “thumbnail” size image, which can be produced as described in commonly assigned U.S. Pat. No. 5,164,831 to Kuchta, et al., the disclosure of which is incorporated by reference herein. The thumbnail image can be stored in RAM memory 322 and supplied to a color display 332, which can be, for example, an active matrix LCD or organic light emitting diode (OLED). After images are captured, they can be quickly reviewed on the color LCD image display 332 by using the thumbnail image data.

The graphical user interface displayed on the color display 332 is controlled by user controls 334. The user controls 334 can include dedicated push buttons (e.g. a telephone keypad) to dial a phone number, a control to set the mode (e.g. “phone” mode, “camera” mode), a joystick controller that includes 4-way control (up, down, left, right) and a push-button center “OK” switch, or the like.

An audio codec 340 connected to the digital processor 320 receives an audio signal from a microphone 342 and provides an audio signal to a speaker 344. These components can be used both for telephone conversations and to record and playback an audio track, along with a video sequence or still image. The speaker 344 can also be used to inform the user of an incoming phone call. This can be done using a standard ring tone stored in firmware memory 328, or by using a custom ring-tone downloaded from a mobile phone network 358 and stored in the image/data memory 330. In addition, a vibration device (not shown) can be used to provide a silent (e.g. non audible) notification of an incoming phone call.

A dock interface 362 can be used to connect the digital camera phone 301 to a dock/charger 364, which is connected to a general control computer 375. The dock interface 362 can conform to, for example, the well-known USB interface specification. Alternatively, the interface between the digital camera 301 and the general control computer 375 can be a wireless interface, such as the well-known Bluetooth wireless interface or the well-know 802.11b wireless interface. The dock interface 362 can be used to download images from the image/data memory 330 to the general control computer 375. The dock interface 362 can also be used to transfer calendar information from the general control computer 375 to the image/data memory in the digital camera phone 301. The dock/charger 364 can also be used to recharge the batteries (not shown) in the digital camera phone 301.

The digital processor 320 is coupled to a wireless modem 350, which enables the digital camera phone 301 to transmit and receive information via an RF channel 352. A wireless modem 350 communicates over a radio frequency (e.g. wireless) link with the mobile phone network 358, such as a 3GSM network. The mobile phone network 358 communicates with a photo service provider 372, which can store digital images uploaded from the digital camera phone 301. These images can be accessed via the Internet 370 by other devices, including the general control computer 375. The mobile phone network 358 also connects to a standard telephone network (not shown) in order to provide normal telephone service.

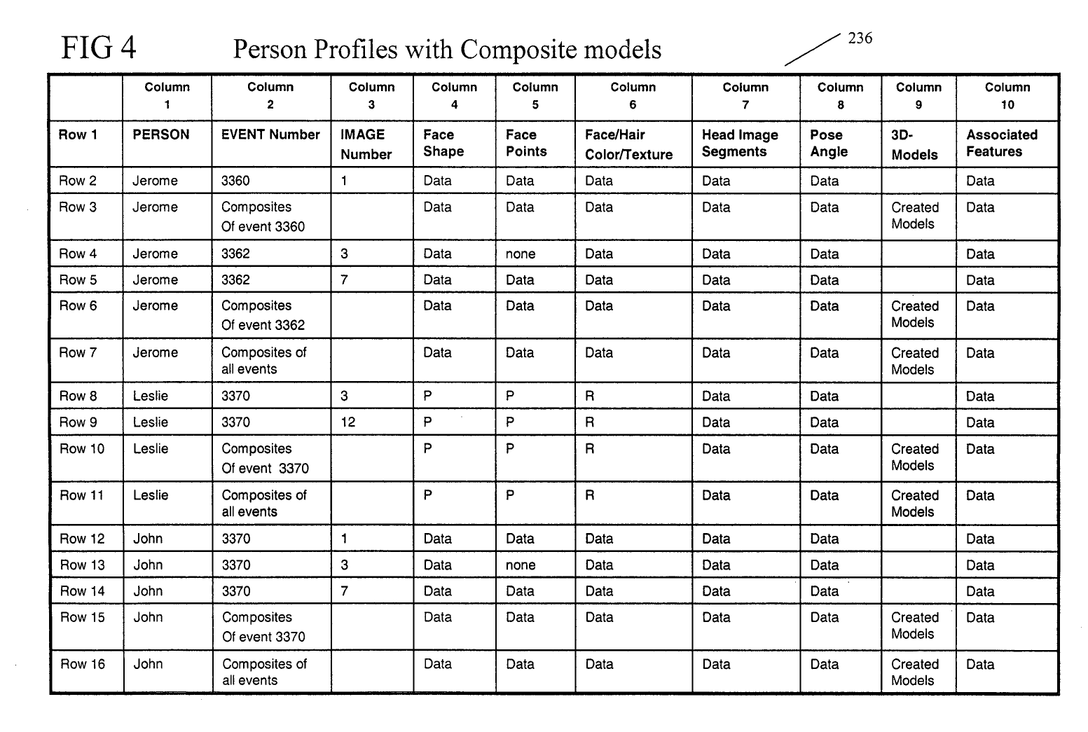

A block diagram of an embodiment of the invention is illustrated in FIG. 2. With brief reference back to FIG. 1., the image/data memory 330, firmware memory 328, RAM 332 and digital processor 330 can be used to provide the necessary data storage functions as described below. Briefly, the diagram contains a database 114 containing a digital image collection 102. Information about the images such as metadata about the images as well as the camera is disclosed as global features 246. Person profile 236 includes information about individuals within the collection. A person profile example is shown in FIG. 4.

An event manager 36 enables improvement of image management and organization by producing digital image sets by relevant time periods using capture time analyzer 272. A global feature detector 242 interprets global features 246 from database 114. Event manager 36 thereby produces digital image collection subset 112. A person finder 108 uses person detector 110 to find persons within the photograph. A face detector 270 finds faces or parts of faces using a local feature detector 240. Associated features with a person can be identified using an associated features detector 238. Person identifier 256 is the assignment of a person's name to a particular person of interest in the collection manually or automatically. This is achieved via an interactive person identifier 250 associated with display 332 and a labeler 104. Furthermore, a person classifier 244 can be employed for automatically applying name labels to persons previously identified in the collection. A Segmentation and Extraction 130 is for person image segmentation 254, using person extractor 252. An associated features segmentation 258 and associated features extractor enables the segmenting and extraction of associated person elements for recording as a composite model 234 in the in the person profile 236. A pose estimator 260 provides a three-dimensional (3D) model creator 262 with detail for the creation of a surface or solid representation model of at least head elements of the person using 3D model creator 262.

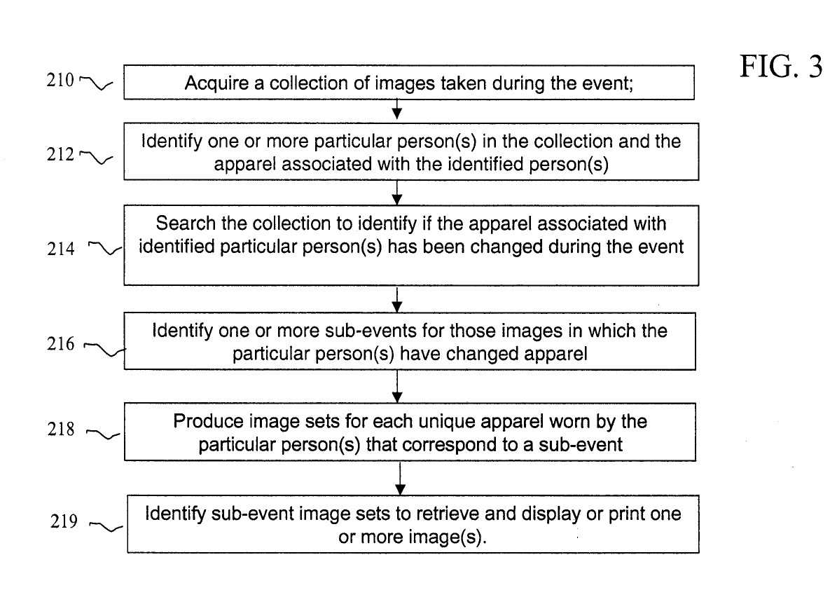

FIG. 3 is a flow chart of an embodiment of the present invention for characterizing images taken during an event into one or more sub-events. Those skilled in the art will recognize that the processing platform for using the present invention can be a camera, a personal computer, a remote computer assessed over a network such as the Internet, a printer, or the like. The system of FIG. 1 can be used to implement the flow chart of FIG. 3.

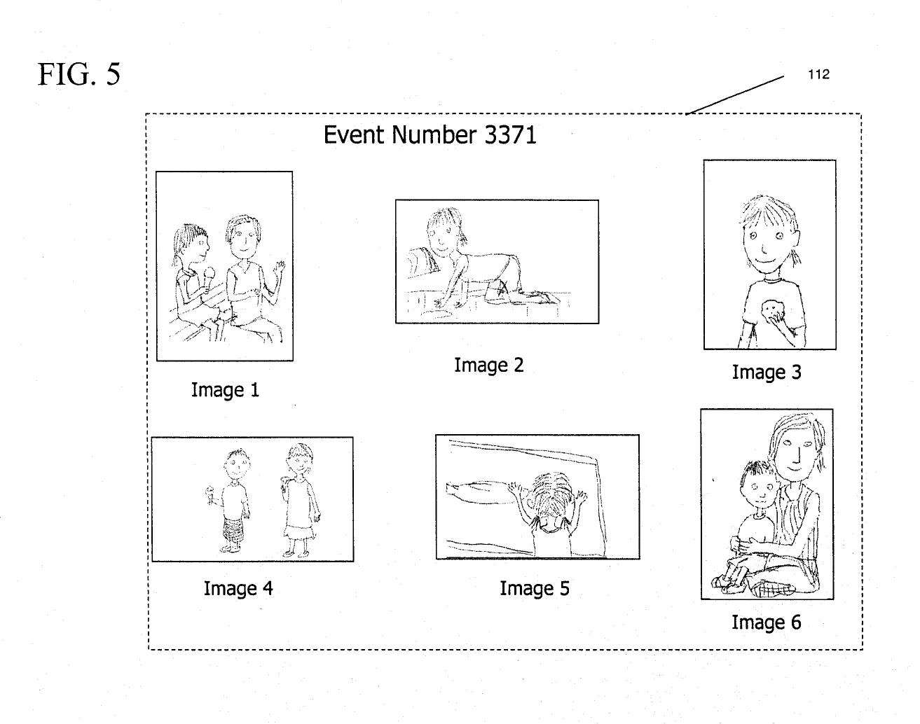

Step 210 is acquiring a collection of images taken at an event. Such a collection can be stored in the image data memory 330 of FIG. 1. Events can be a birthday party, vacation, collection of family moments or a soccer game. Such events can also be broken into sub-events. A birthday party can comprise cake, presents, and outdoor activities. A vacation can be a series of sub-events associated with various cities, times of the day, or other sub-events such as visits to the beach. An example of a set of images identified as an event is shown in FIG. 5. Events can be tagged manually or automatically.

Commonly assigned U.S. Pat. Nos. 6,606,411 and 6,351,556, disclose algorithms for image set production into temporal events and sub-events. The disclosures of the above patents are herein incorporated by reference.

U.S. Pat. No. 6,606,411 teaches that events have consistent color distributions, and therefore, these pictures are likely to have been taken with the same backdrop. For each sub-event, a single color and texture representation is computed for all background areas taken together. The above patents teach how to produce sets of images and videos in a digital image collection into temporal events and sub-events. The terms “event” and “sub-event” are used in an objective sense to indicate the products of a computer mediated procedure that attempts to match a user's subjective perceptions of specific occurrences (corresponding to events) and divisions of those occurrences (corresponding to sub-events). A collection of images is classified into one or more events determined by one or more largest time differences in the collection of images based on time or date.

Furthermore, for each event, sub-events (if any) can be determined by comparing the color histogram information of successive images as described in U.S. Pat. No. 6,351,556. Dividing an image into a number of blocks and then computing the color histogram for each of the blocks accomplish this. A block-based histogram correlation procedure is used as described in U.S. Pat. No. 6,351,556 to detect sub-event boundaries.

Another method of automatically organizing images into events is disclosed in commonly assigned U.S. Pat. No. 6,915,011, which is herein incorporated by reference. In accordance with the present invention, an event set production method uses foreground and background segmentation for set production images from a group into similar events. Initially, each image is divided into a plurality of blocks, thereby providing block-based images. Using a block-by-block comparison, each block-based image is segmented into a plurality of regions comprising at least a foreground and a background. One or more luminosity, color, position or size features are extracted from the regions and the extracted features are utilized to estimate and compare the similarity of the regions comprising the foreground and background in successive images in the group. A measure of the total similarity between successive images is then computed, thereby providing image distance between successive images, and event sets are delimited from the image distances.

A further benefit of image event sets is that within an event or sub-event, there is a high likelihood that the person is wearing the same clothing or associated features. However, a marker that the sub-event has changed could be if a person has changed clothing. For example, a trip to the beach can soon be followed by a trip to a restaurant during a vacation. The vacation is the super-event and the beach can be where a swimsuit is worn identified as one sub-event, followed by a restaurant outing with a suit and a tie.

The set production of images into events is further beneficial to consolidate similar lighting, clothing, and other features associated with a person for the creation of a composite model 234 of a person in person profile 236.

Step 212, identification of images having a particular person in the collection and the apparel associated with the identified person, uses person finder 108. The digital processor 320, firmware memory 328 and associated logic of FIG. 1 can be used to implement step 212. Person finder 108 detects persons and provides a count of persons in each photograph in an acquired collection of event images to the event manager 36 using such methods as described in commonly assigned U.S. Pat. No. 6,697,502 to Luo, the disclosure of which is herein included as reference.

In accordance with the present invention, skin detection utilizes color image segmentation by classification of the average color of a segmented region. A probability value can also be retained in case a subsequent human figure-constructing step needs a probability instead of a binary decision.

The skin detection method is based on human skin color distributions in the luminance and chrominance components. Furthermore, a skin probability is calculated and a skin region is declared if the probability is greater than a pre-determined threshold.

Face detector 270 identifies potential faces based on detection of major facial features using local feature detector 240 (eyes, eyebrows, nose, and mouth) within the candidate skin regions. The flesh map output by the skin detection step combines with other face-related heuristics to output a belief in the location of faces in an image. Each region in an image that is identified as a skin region is fitted with an ellipse wherein the major and minor axes of the ellipse are calculated as also the number of pixels in the region outside of the ellipse and the number of pixels in the ellipse that are not part of the region. The aspect ratio is computed as a ratio of the major axis to the minor axis. The probability of a face is a function of the aspect ratio of the fitted ellipse, the area of the region outside the ellipse, and the area of the ellipse not part of the region. Again, the probability value can be retained or simply compared to a pre-determined threshold to generate a binary decision as to whether a particular region is a face or not. In addition, texture in the candidate face region can be used to further characterize the likelihood of a face. Valley detection is used to identify valleys, where facial features (eyes, nostrils, eyebrows, and mouth) often reside. This process is necessary for separating non-face skin regions from face regions.

In a preferred embodiment, the method of locating facial feature points based on an active shape model of human faces described in “An automatic facial feature finding system for portrait images”, by Bolin and Chen in the Proceedings of IS&T PICS conference, 2002 is used.

The local features are quantitative descriptions of a person. Preferably, the person finder 108 and feature extractor 106 (as shown in FIG. 2) outputs one set of local features and one set of global features 246 for each detected person. Preferably the local features are based on the locations of 82 feature points associated with specific facial features.

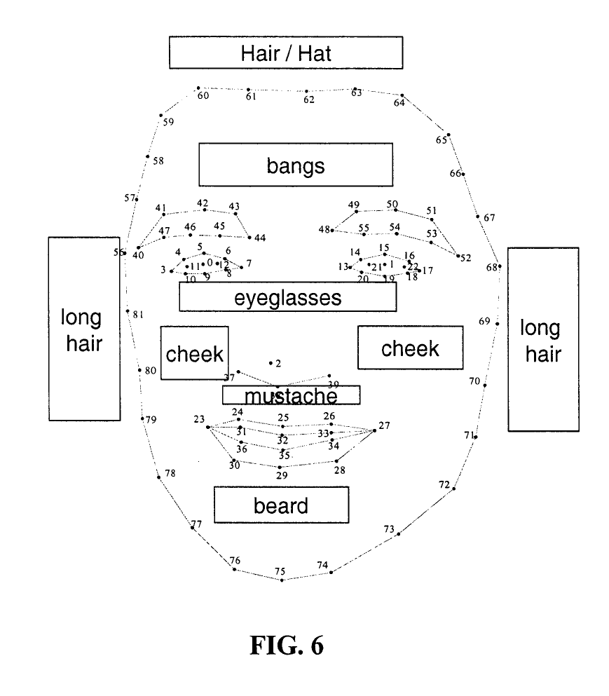

A visual representation of the local feature points for an image of a face is shown in FIG. 6 as an illustration. The local features can also be distances between specific feature points or angles formed by lines connecting sets of specific feature points, or coefficients of projecting the feature points onto principal components that describe the variability in facial appearance.

Alternatively, different local features can also be used. For example, an embodiment can be based upon the facial similarity metric described by M. Turk and A. Pentland, in “Eigenfaces for Recognition”; Journal of Cognitive Neuroscience; Vol. 3, No. 1; 71-86, 1991. Facial descriptors are obtained by projecting the image of a face onto a set of principal component functions that describe the variability of facial appearance. The similarity between any two faces is measured by computing the Euclidean distance of the features obtained by projecting each face onto the same set of functions.

The local features could include a combination of several disparate feature types such as Eigenfaces, facial measurements, color/texture information, and wavelet features. Alternatively, the local features can additionally be represented with quantifiable descriptors such as eye color, skin color, hair color/texture, and face shape.

In some cases, a person's face cannot be visible as they have their back to the camera. However, when a clothing region is matched, detection and analysis of hair can be used on the area above the matched region to provide additional cues for person counting as well as the identity of the person present in the image. Yacoob and David describe a method for detecting and measuring hair appearance for comparing different people in “Detection and Analysis of Hair” in IEEE Trans. on PAMI, Vol. 28, No. 7; pp. 1164-1169; July 2006. The Yacoob and David method produces a multidimensional representation of hair appearance that includes hair color, texture, volume, length, symmetry, hair-split location, area covered by hair and hairlines.

Furthermore, in some images, there are limitations to the amount of people these algorithms are able to identify. The limitations are generally due to the limited resolution of the people in the pictures. In situations like this, the event manager 36 can evaluate the neighboring images for the number of people who are important to the event or jump to a mode where the count is input manually.

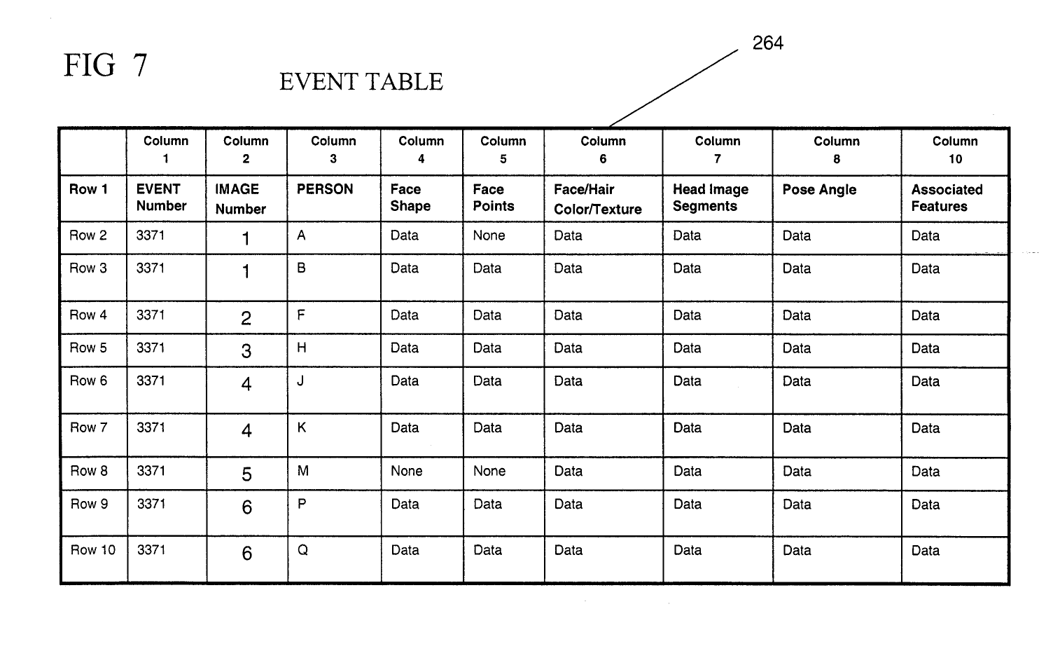

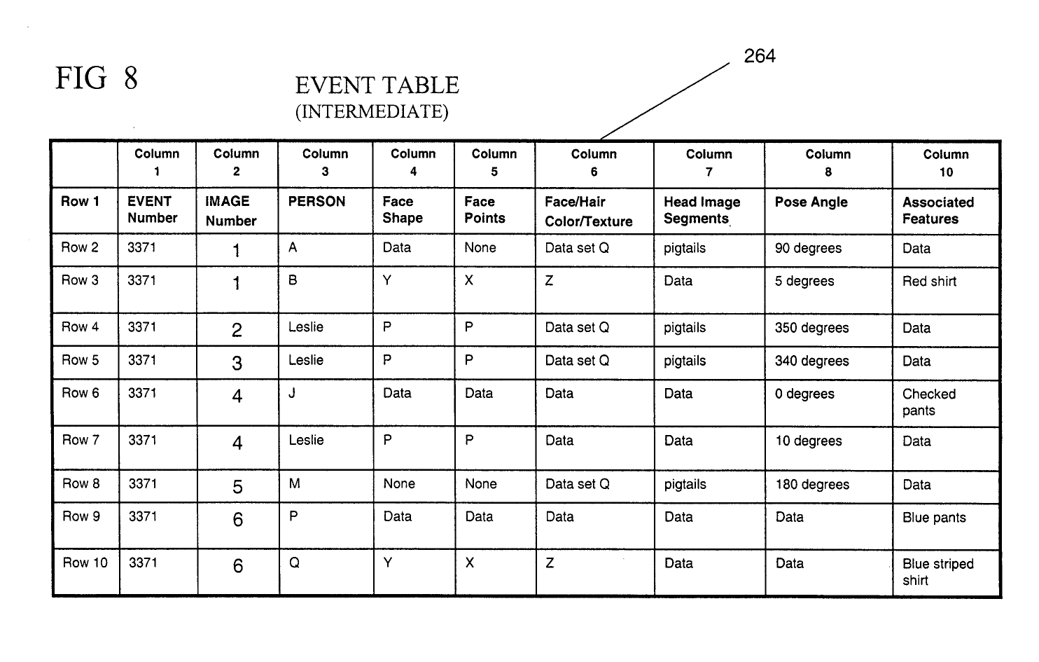

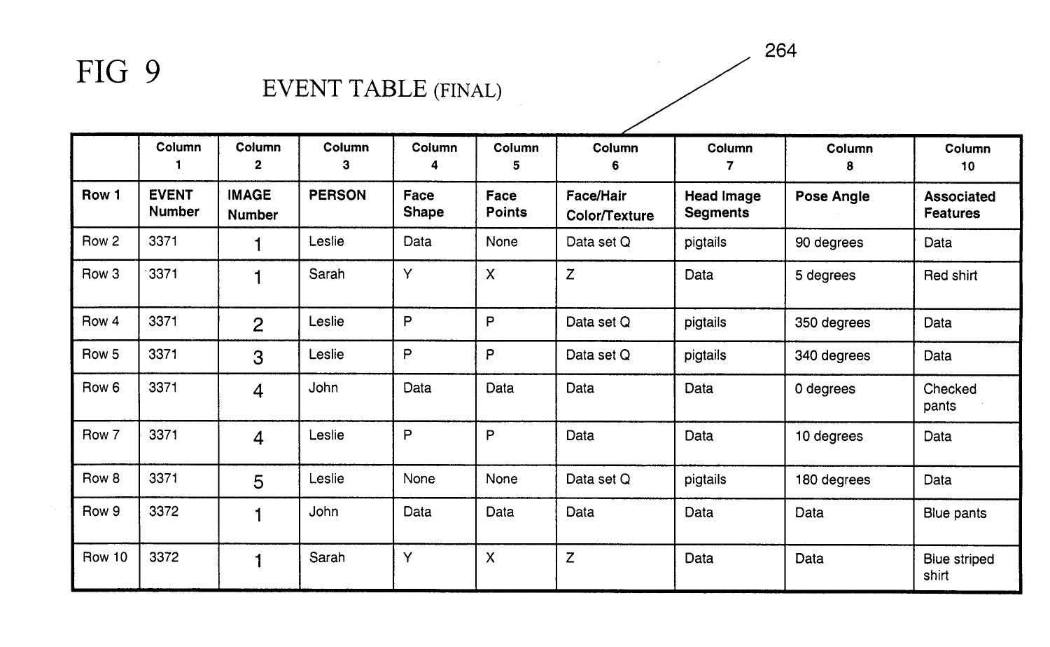

Once a count of the number of relevant persons in each image in FIG. 5 is established, event manager 36 builds an event table 264 shown in FIG. 7, FIG. 8, and FIG. 9 incorporating relevant data to the event. Such data can comprise number of images, and number of persons per image. Additionally, head, head pose, face, hair, and associated features of each person within each image can be determined without knowing who the person is. In FIG. 7, building on previous event data shown in personal profile 236 in FIG. 4, the event number is assigned to be 3371.

If an image contains a person that the database 114 has no record of, the interactive person identifier 250 displays the identified face with a circle around it in the image. Thus, a user can label the face with the name and any other types of data. Note that the terms “tag”, “caption”, and “annotation” are used synonymously with the term “label.” However, if the person has appeared in previous images, data associated with the person can be retrieved for matching using any of the previously identified person classifier 244 algorithms using the personal profile 236 database 114 like the one in shown in FIG. 4, row 1, wherein the data is segmented into categories. Such recorded distinctions are person identity, event number, image number, face shape, face points, Face/Hair Color/Texture, head image segments, pose angle, 3D models and associated features. Each previously identified person in the collection has a linkage to the head data and associated features detected in earlier images. Furthermore, produced composite model(s) 234 of sets of images are also stored in conjunction with the name and associated event identifier. Using this data, person classifier 244 identifies image(s) having a particular person in the collection. Returning to FIG. 5, Image 1, the left person is not recognizable using the 82 point face model or an Eigenface model. The second person has 82 identifiable points and an Eigenface structure, yet there is no matching data for this person in person profile 236 shown in FIG. 4. In image 2, the person does fit a connection to a face model as data set “P” belonging to Leslie. Image 3 and the right person in image 4 also match face model set “P” for Leslie. An intermediate representation of this event data is shown in FIG. 8.

In addition, one or more unique features in the identified image(s) associated with the particular person are identified. Associated features are the presence of any object associated with a person that can make them unique. Such associated features include eyeglasses, or description of apparel. For example, Wiskott describes a method for detecting the presence of eyeglasses on a face in “Phantom Faces for Face Analysis”, Pattern Recognition, Vol. 30, No. 6, pp. 837-846, 1997. The associated features contain information related to the presence and shape of glasses.

Briefly stated, person classifier 244 can measure the similarity between sets of features associated with two or more persons to determine the similarity of the persons, and thereby the likelihood that the persons are the same. Measuring the similarity of sets of features is accomplished by measuring the similarity of subsets of the features. For example, when the associated features describe clothing, the following method is used to compare two sets of features. If the difference in image capture time is small (i.e. less than a few hours) and if the quantitative description of the clothing is similar in each of the two sets of features is similar, then the likelihood of the two sets of local features belonging to the same person is increased. If, additionally, the apparel has a very unique or distinctive pattern (e.g. a shirt of large green, red, and blue patches) for both sets of local features, then the likelihood is even greater that the associated people are the same individual.

Apparel can be represented in different ways. The color and texture representations and similarities described in U.S. Pat. No. 6,480,840 to Zhu and Mehrotra can be used. In another representation, Zhu and Mehrotra describe a method specifically intended for representing and matching patterns such as those found in textiles in U.S. Pat. No. 6,584,465. This method is color invariant and uses histograms of edge directions as features. Alternatively, features derived from the edge maps or Fourier transform coefficients of the apparel patch images can be used as features for matching. Before computing edge-based or Fourier-based features, the patches are normalized to the same size to make the frequency of edges invariant to distance of the subject from the camera/zoom. A multiplicative factor is computed which transforms the inter-ocular distance of a detected face to a standard inter-ocular distance. Since the patch size is computed from the inter-ocular distance, the apparel patch is then sub-sampled or expanded by this factor to correspond to the standard-sized face.

A uniqueness measure is computed for each apparel pattern that determines the contribution of a match or mismatch to the overall match score for persons. The uniqueness is computed as the sum of uniqueness of the pattern and the uniqueness of the color. The uniqueness of the pattern is proportional to the number of Fourier coefficients above a threshold in the Fourier transform of the patch. For example, a plain patch and a patch with single equally spaced stripes have 1 (dc only) and 2 coefficients respectively, and thus have low uniqueness score. The more complex the pattern, the higher the number of coefficients that will be needed to describe it, and the higher its uniqueness score. The uniqueness of color is measured by learning, from a large database of images of people, the likelihood that a particular color occurs in clothing. For example, the likelihood of a person wearing a white shirt is much greater than the likelihood of a person wearing an orange and green shirt. Alternatively, in the absence of reliable likelihood statistics, the color uniqueness is based on its saturation, since saturated colors are both rarer and can be matched with less ambiguity. In this manner, apparel similarity or dissimilarity, as well as the uniqueness of the apparel, taken with the capture time of the images are important features for the person classifier 244 to recognize a person of interest. Associated feature uniqueness is measured by learning, from a large database of images of people, the likelihood that particular clothing appears. For example, the likelihood of a person wearing a white shirt is much greater than the likelihood of a person wearing an orange and green plaid shirt. In this manner, apparel similarity or dissimilarity, as well as the uniqueness of the apparel, taken with the capture time of the images are important features for the person classifier 244 to recognize a person of interest.

When one or more associated features are assigned to a person, additional verification steps can be necessary to determine uniqueness. It is possible that all of the kids are wearing soccer uniforms, so that in this case, are only distinguished by the numbers and faces as well as glasses or perhaps shoes and socks. Once the uniqueness is identified, these features are stored as unique. One embodiment is to look around the person's face starting with the center of the face in a head-on view. Moles can be attached to cheeks. Jewelry can be attached to ears, tattoos or make-up and glasses can be associated with the eyes, forehead or face, hats can be above or around the head, scarves, shirts, swimsuits or coats can be around and below the head. Additional tests can be the following:
a) Two people within the same image contain the same associated features but have different features (thus ruling out a mirror image of the same person, as well as the usage of these same associated features as unique features).
b) At least two positive matches for different faces of at least two persons in all images that contain the same associated feature (thus ruling out these associated features as unique features).
c) A positive match for the same person in different images but with substantially different apparel. (This is a signal that a new outfit is worn by the person, signaling a different event or sub-event, which can be recorded and corrected by the event manager 36, in conjunction with the person profile 236 in database 114).

In the example of the images shown in FIG. 5, and recorded in FIG. 8, column 7, pigtails are identified as a unique associated feature with Leslie.

Step 214 is searching the collection to identify if the apparel associated with identified particular person(s) has been changed during this event. Computing functions shown in FIG. 1 can implement this step. With each of the positive views of a person, unique features can be extracted from the image file(s) 30 and compared in remaining images. A pair of glasses can be evident in a front and side view. Hair, hat, shirt or coat can be visible in all views.

Objects associated with a particular person can be matched in various ways depending on the type of object. For objects that contain a number of parts or segments (for example, bicycles, cars), Zhang and Chang describe a model called Random Attributed Relational Graph (RARG) in the Proc. of IEEE CVPR 2006. In this method, probability density functions of the random variables are used to capture statistics of the part appearances and part relations, generating a graph with a variable number of nodes representing object parts. The graph is used to represent and match objects in different scenes.

Methods used for objects without specific parts and shapes (for example, apparel) include low-level object features such as color, texture or edge-based information that can be used for matching. In particular, Lowe describes scale-invariant features (SIFT) in International Journal of Computer Vision, Vol. 60, No 2.; 2004 that represent interesting edges and corners in any image. Lowe also describes methods for using SIFT to match patterns even when other parts of the image change and there is change in scale and orientation of the pattern. This method can be used to match distinctive patterns in clothing, hats, tattoos and jewelry.

SIFT methods can also have use for local features. In “Person-Specific SIFT features for Face Recognition” by Luo et al. published in the “Proceedings of the IEEE International Conf. on Acoustics, Speech and Signal Processing (ICASSP), Honolulu, Hi., Apr. 15-20, 2007”. The authors use the person-specific SIFT features and a simple non-statistical matching strategy combined with local and global similarity on key-point clusters to solve face recognition problems.

There are also additional methods dedicated to finding specific commonly occurring objects such as eyeglasses. Wu et al describe a method for automatically detecting and localizing eyeglasses in IEEE Transactions on PAMI, Vol. 26, No. 3, 2004. Their work uses a Markov-chain Monte Carlo method to locate key points on the eyeglasses frame. Once eyeglasses have been detected, their shape can be characterized and matched across image.

Referring back to the collection of event images in FIG. 5 as described in FIG. 8, using color and texture mapping to segment and extract image shapes, pigtails can provide a positive match for Leslie in images 1 and 5. Moreover, Data set Q, associated with Leslie's hair color and texture as well as the clothing color and patterns can provide confirmation of the lateral assignment across images of associated features to the particular person.

Upon the detection of these types of unique associated features, the person classifier 244 labels the particular person the identity earlier labeled, in this example, Leslie.

Additionally, segmenting and then extracting head elements and features from identified images containing the particular person can be performed using any common image segmentation technique. Head elements and individual associated features are filed by name in personal profile 236.

With the associated features identified, it is the object to construct a composite model of at least a portion of a person's head using identified elements and extracted features and image segments. A composite model 234 is a subset of person profile 236 information associated with an image collection. The composite model 234 can further be defined as a conceptual whole made up of complicated and related parts containing at least various views extracted of a person's head and body. The composite model 234 can further include features derived from and associated with a particular person. Such features can include defining features such as apparel, eyewear, jewelry, ear attachments (hearing aids, phone accessories), tattoos, make-up, facial hair, facial defects such as moles, scars, as well as prosthetic limbs and bandages. Apparel is generally defined as the clothing one is wearing. Apparel can comprise shirts, pants, dresses, skirts, shoes, socks, hosiery, swimsuits, coats, capes, scarves, gloves, hats and uniforms. This color and texture feature is typically associated with an article of apparel. The combination of color and texture is typically referred to as a swatch. Assigning this swatch feature to an iconic or graphical representation of a generic piece of apparel can lead to the visualization of such an article of clothing as if it belonged to the wardrobe of the identified person. Creating a catalog or library of articles of clothing can lead to a determination of preference of color for the identified person. Such preferences can be used to produce or enhance a person profile 236 of a person that can further be used to offer similar or complementary items for purchase by the identified and profiled person.

Person identification is continued using interactive person identifier 250 and person classifier 244 until all of the faces of identifiable people are classified in the collection of images taken at an event. If John and Jerome are brothers, the facial similarity can require additional analysis for person identification. In the family photo domain, the face recognition problem entails finding the right class (person) for a given face among a small (typically in the 10s) number of choices. Using the pair-wise classification paradigm can solve this multi-class face recognition problem; where two-class classifiers are designed for each pair of classes. The advantage of using the pair-wise approach is that actual differences between two persons are explored independently of other people in the data set, making it possible to find features and feature weights that are most discriminating for a specific pair of individuals. In the family photo domain, there are often resemblances between people in the database, making this approach more appropriate. The small number of main characters in the database also makes it possible to use this approach. This approach has been shown by Zhang et al, Facial Expression Recognition Using Continuous Dynamic Processing, IEEE ICCV 2001 to improve face recognition performance over standard approaches that use the same feature set for all faces. Another observation noted by them is that the number of features required to obtain the same level of performance is much smaller when using the pair-wise approach than when a global feature set is used. Some face pairs can be completely separated using only one feature, and most require less than 10% of the total feature set. This is to be expected, since the features used are targeted to the main differences between specific individuals. The benefit of a composite model 234 is that it enables a wide variety of facial features for analysis. In addition, trends can be spotted by adaptive systems for unique features as they appear. In addition, hair may be of two modes, one color and then another, one set of facial hair then another. Typically, these trends are limited to a multimodal distribution. These few modes can be supported in a composite model of images that are divided into event sets.

In the example, John has a match for face points and Eigenfaces, and the person classifier names the person John. The uncertain person with face shape y, face points x and face hair color and texture z is identified as Sarah by the user using interactive person identifier 250. Alternatively, Sarah may be identified using data from a different database located on another computer, camera, Internet server or removable memory using person classifier 244.

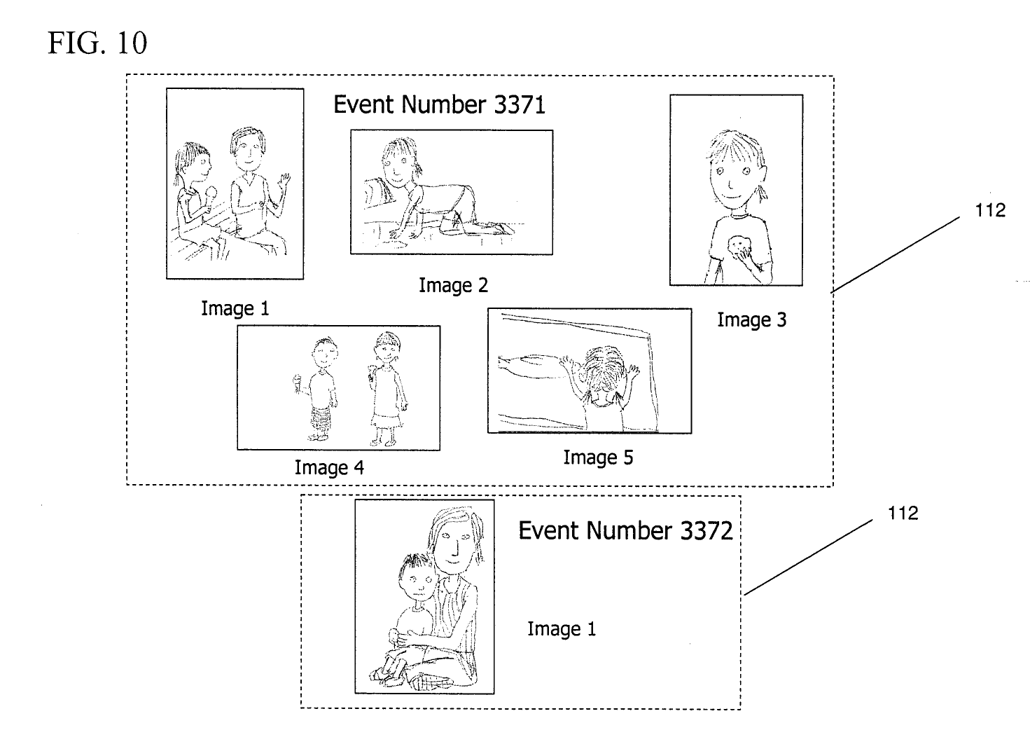

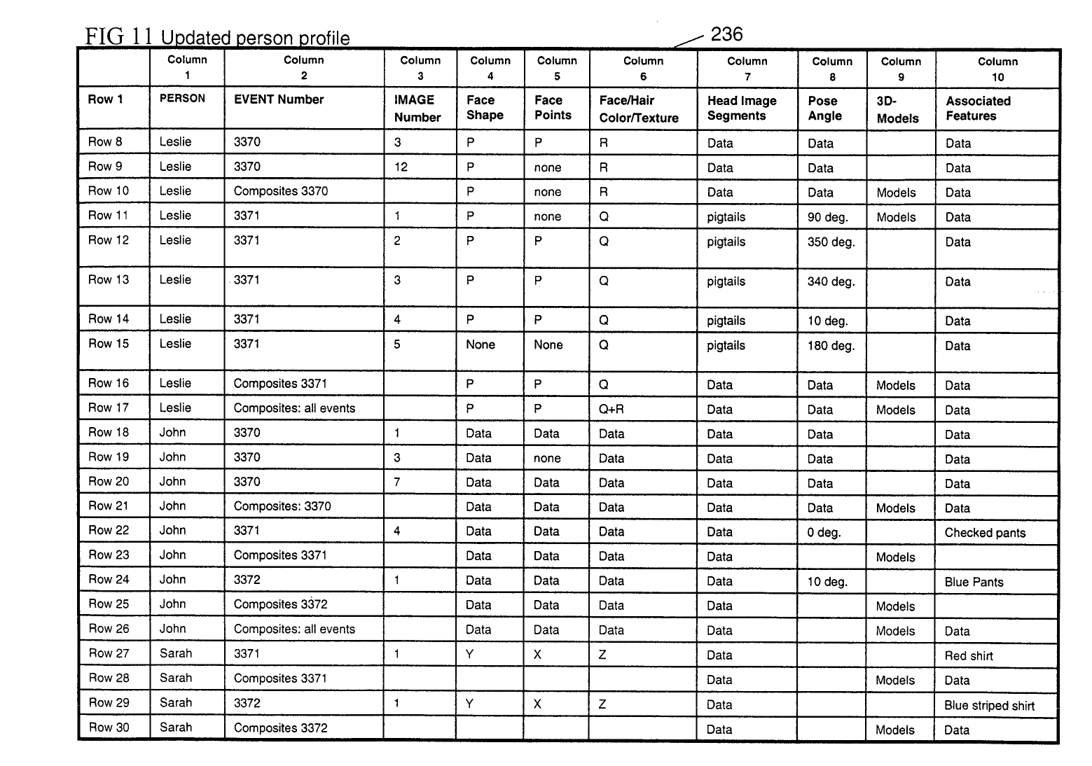

Identification of one or more sub-events for those images in which the particular person(s) have changed apparel (step 216) is performed. In the example of images from an event in FIG. 5, new clothes are associated with Sarah and new pants are associated with John. The event has changed this marker. To further refine the classification of images into events, event manager 36 modifies the event table 264 shown in FIG. 9 to produce a new event number, 3372. As a result, event table 264 in FIG. 9 now is complete with person identification and an updated set of images is shown in FIG. 10. Data in FIG. 9 can be added to FIG. 4 resulting in an updated person profile 236 as shown in FIG. 11. Note that in FIG. 11, column 6, in Rows 8-16, the data set has changed for Face/Hair Color/Texture for Leslie. It is possible that the hair has changed color from one event to the next, with this data incorporated into a person profile 236. Thus, event image sets are produced for each unique apparel worn by the particular person(s) that correspond to a sub-event (step 218).

Further extracting data from the event sets is to assemble segments of at least a portion of the particular person's head from an event. These segments can be separately used as the composite model and are acquired from the event table 264 or the person profile 236. Head pose is an important visual cue that enhances the ability of vision systems to process facial images. This step can be performed before or after persons are identified.

Head pose includes three angular components: yaw, pitch, and roll. Yaw refers to the angle at which a head is turned to the right or left about a vertical axis. Pitch refers to the angle at which a head is pointed up or down about a lateral axis. Roll refers to the angle at which a head is tilted to the right or left about an axis perpendicular to the frontal plane. Yaw and pitch are referred to as out-of-plane rotations because the direction in which the face points changes with respect to the frontal plane. By contrast, roll is referred to as an in-plane rotation because the direction in which the face points does not change with respect to the frontal plane.

Model-based techniques for pose estimation typically reproduce an individual's 3-D head shape from an image and then use a 3-D model to estimate the head's orientation.

Appearance-based techniques for pose estimation can estimate head pose by comparing the individual's head to a bank of template images of faces at known orientations. The individual's head is believed to share the same orientation as the template image it most closely resembles.

In addition, three-dimensional representation(s) of the particular person's head can be produced. With the head examples of the three persons identified in FIG. 10, there are three disparate views of Leslie to produce a sufficient 3D model. The other persons in the images have some data for model creation, but it will not be as accurate as the one for Leslie. Some of the extracted features could be mirrored and tagged as such for composite model creation. However, the person profile 236 of John will have earlier images that can be used to produce a composite 3D model from earlier events combined with this event.

Three-dimensional representations are beneficial for subsequent searching and person identification. These representations are useful for avatars associated with persons narrating, gaming, and animation. A series of these three-dimensional models can be produced from various views in conjunction with pose estimation data as well as lighting and shadow tools. Camera angle derived from a GPS system can enable consistent lighting, thus improving the 3D model creation. If one is outside, lighting may be similar if the camera is pointed in the same direction relative to the sunlight. Furthermore if the background is the same for several views of the person, as established in the event manager 36, similar lighting can be assumed. It is desired as well, to compile a 3D model from many views of a person in a short period of time. These multiple views can be integrated into 3D models with interchangeable expressions based on several different front views of a person.

3D models can be produced from one or several images with the accuracy increased with the number of images combined with head sizes large enough to provide sufficient resolution. The present invention makes use of known methods that use an array of mesh polygons or a baseline parametric or generic head model. Texture maps or head feature image portions are applied to the produced surface to generate the model.

Furthermore, composite image files can be stored associated with the particular person's identity combined with at least one metadata element from the event. This enables a series of composite models over the events in a photo collection. These composite models are useful for grouping appearance of a particular person by age, hairstyle, or clothing. If there are substantial time gaps in the image collection, image portions with similar pose angle can be morphed to fill in the gaps of time. Later, this can aid the identification of a person upon the addition of a photograph from the time gap.

In step 219, the sub-event image sets produced in step 218 can be stored in image data memory 330. These sub-event image sets can be accessed by the user to display selected images on display 332 of FIG. 1 or delivered to general control block 375 which can include a printer that prints image(s).

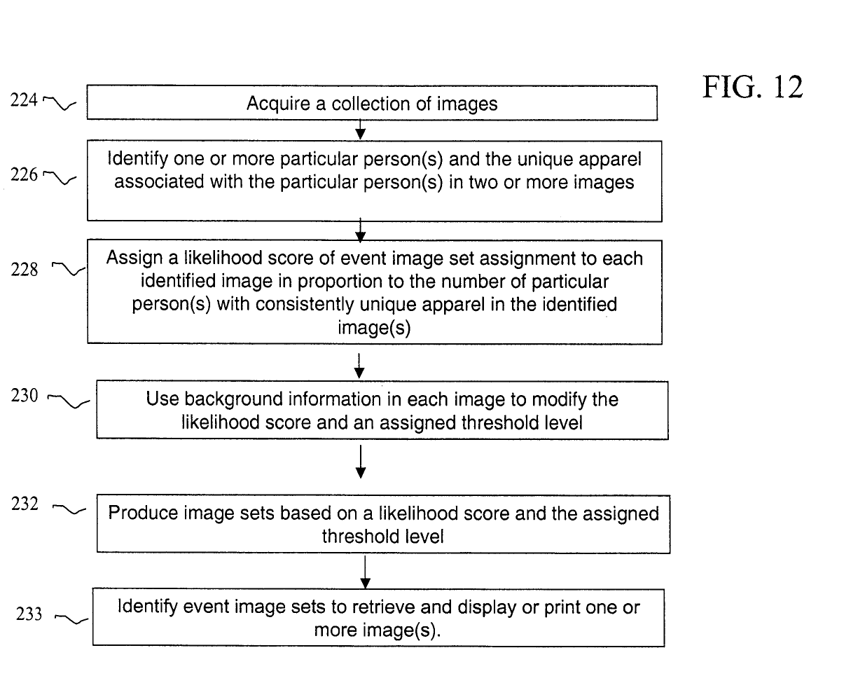

Referring to FIG. 12, a flow chart for a method of dividing images into event image sets is set forth. The system of FIG. 1 can be used to implement the flow chart of FIG. 12.

Step 224 is to acquire a collection of images. These images can be stored in image/data memory 330 of FIG. 1. Step 226 is to identify one or more particular person(s) and the unique apparel associated with the particular person(s) in two or more images. This is achieved using steps 210 and 212 described earlier. Step 228 is to assign a likelihood score of event image set assignment to each identified image in proportion to the number of particular person(s) with consistently unique apparel in the identified image(s). A likelihood score can be applied incorporating several variables that determine the effectiveness of an event image set producing algorithm using facial discrimination and apparel. Variable one is the ability to distinguish one person from another. The use of a composite model improves the performance to detect the person in many different pose angles. Variable two is the ability to determine apparel sameness from image to image. Scale invariant feature algorithms are one embodiment for clothing pattern sameness determination. Variable three is the consideration of apparel that is best suited for event correlation. A shift from glasses to sunglasses is not a good event boundary indicator. Other poor boundary indicators are the presence of easily removed apparel such as hats, jackets or repeatedly worn on many occasions. Variable 4 is the number of identified persons in the image. If a particular person has ten different shirts that are of equal preference to the particular person and thus worn at equal amounts of time, that person would wear the same shirt once every ten events. This alone a low likelihood indicator for event image set production. However if five people in several pictures each have the consistently unique apparel, the likelihood score is quite high that these images are from the same event. Thus, for each image with a greater number of identified people wearing consistent clothing, a likelihood score increases in proportion. In another embodiment, step 230 is to incorporate background information in images as described in the cited references by Loui and Das in conjunction with step 228 to modify the likelihood score. If Leslie wears a red shirt in an image with three other people with an identifiable background characteristic, an image of Leslie alone with a red shirt and the same identifiable background characteristic will have a greater likelihood score of correct assignment to the event. In addition, although several people wearing uniforms can make it difficult to determine exact identities in many views, the presence of many identical uniforms in several images is a good event image set indication. This can be a soccer game or baseball game. Once these images are divided into sets, it can be apparent that there is more than one event in the grouping of images. The identification of two sets of uniforms on several people indicates that there is an opposing team. Sorting for two sets of colors of apparel also increases the likelihood score of the event image set. In another embodiment, additional sorting techniques can be employed to improve the likelihood score. This can include indoors versus outdoors image information or background histograms. A group of cheerleaders can be present at several events and the background can create an improved likelihood score. In addition, further embodiments produce event image sets based on the threshold level, (step 232). The user based on experience with one's individual image collection for event set production can vary the threshold level. In step 233, the event image sets produced in step 232 can be stored in image data memory 330. These sets can be accessed by the user to display selected images on display 332 of FIG. 1 or delivered to general control block 375 which can include a printer that prints image(s).

Those skilled in the art will recognize that many variations can be made to the description of the present invention without significantly deviating from the scope of the present invention.

### PARTS LIST

36 event manager
102 digital image collection
104 labeler
106 feature extractor
108 person finder
110 person detector
112 digital image collection subset
114 database
130 extraction and segmentation.
210 step
212 step
214 step
216 step
218 step
219 step
224 step
226 step
228 step
230 step
232 step
233 step
234 composite model
236 person profile
238 associated features detector
240 local feature detector
242 global feature detector
244 person classifier
246 global features
250 interactive person identifier
252 person extractor
254 person image segmentor
256 person identifier
258 associated features segmentor
260 pose estimator
262 3D model creator
264 event table
270 face detector
272 capture time analyzer
301 digital camera phone
303 flash
305 lens
311 CMOS image sensor
312 timing generator
314 image sensor array
316 A/D converter circuit
318 DRAM buffer memory
320 digital processor
322 RAM memory
324 real-time clock
325 location determiner
328 firmware memory
330 image/data memory
332 color display
334 user controls
340 audio codec
342 microphone
344 speaker
350 wireless modem
352 RF channel
358 phone network
362 dock interface
364 dock/charger
370 Internet
372 service provider
375 general control computer

1. A method of characterizing images taken during a event into one or more sub-events, comprising:
a) acquiring a collection of images taken during the event;
b) identifying one or more particular person(s) in the collection and the apparel associated with the identified person(s);
c) searching the collection to identify if the apparel associated with identified particular person(s) has been changed during the event; and
d) identifying one or more sub-events for those images in which the particular person(s) have changed apparel.

2. The method of claim 1 wherein step d includes producing image sets for each unique apparel worn by the particular person(s) that correspond to a sub-event.

3. The method of claim 1 wherein step b is either performed by a user or performed automatically.

4. The method of claim one further including using identified sub-event image sets to retrieve and display or print one or more image(s).

5. A method of dividing images into event image sets, comprising:
a) acquiring a collection of images;
b) identifying one or more particular person(s) and the unique apparel associated with the particular person(s) in two or more images and;
c) assigning a likelihood score of event image set assignment to each identified image in proportion to the number of particular person(s) with consistently unique apparel in the identified image(s).

6. The method of claim 5 wherein step b is either performed by a user or automatically.

7. The method of claim 5 wherein step c includes using the background information in each image to modify the likelihood score.

8. The method of claim 5 wherein step c includes producing event image sets based upon the likelihood score and an assigned threshold level.

9. The method of claim 7 wherein step c includes using the background information in each image to modify the likelihood score.

10. The method of claim 8 further including using identified event image sets to retrieve and display or print one or more image(s).
